(19) United States
(12) Patent Application Publication
(10) Pub. No.: US 2006/0012240 A1
(43) Pub. Date: Jan. 19, 2006

(54) CENTERING DEVICE, KIT AND METHOD

(76) Inventor: JAMES H. ANDERSEN, Windsor, CO (US)

Correspondence Address: ANCEL W. LEWIS, JR., 425 WEST MULBERRY, SUITE 101, FORT COLLINS, CO, 80521, US

(21) Appl. No.: 11/162,996

(22) Filed: Sep. 30, 2005

Related U.S. Application Data
(63) Continuation-in-part of application No. 10/868,687, filed on Jun. 15, 2004.

(51) Int. Cl. B60B 1/00

(52) U.S. Cl. 301/35.629

(57) ABSTRACT

A wheel centering pin or device disclosed for vehicle wheels having apertures of uniform diameter. The wheel centering pin is provided as a set of three that are threaded on three circumferentially spaced hub bolts on which a wheel is mounted to center the wheel. Nuts are threaded on the remaining bolts and tightened to fasten the wheel to the hub. The centering pins are removed, and remaining nuts are applied in their place and tightened on the remaining bolts to center the wheel. Other forms of centering devices include hollow bodies with a wheel centering sleeve portion and a flange at one end of the sleeve portion and a wheel centering portion and a nut portion at one end of the sleeve portion. These other forms remain on the wheels during vehicle usage.

This is a continuation-in-part application of Ser. No. 10/868,687 filed Jun. 15, 2004.

### TECHNICAL FIELD

The present invention relates to mounting vehicle wheels on hubs and more particularly to a device, kit and method for centering a vehicle wheel, particularly a truck wheel, on a hub.

### BACKGROUND ART

In the past vehicle wheels have typically incorporated a taper or bevel on each wheel aperture and a complementary taper on the wheel nut to center the wheel on the hub when the wheel is mounted. Presently there are truck wheels such as the 22.5 and 24.5 UNI-Mount truck wheels that have wheel apertures of uniform diameter and use flanged nuts with no taper. This construction does not ensure the wheel is centered on the hub during mounting. If the wheel is not centered on the hub, the wheel is usually unbalanced and results in unnecessary tire wear.

### SUMMARY OF THE INVENTION

A wheel or centering pin or device disclosed is used as a set of three that are threaded on three hub bolts to center the wheel on the hub during wheel mounting. The wheel centering pin has a hollow main body with a sleeve portion, preferably cylindrical with an exterior surface of uniform diameter sized to slide into and substantially fill one of the wheel apertures when the wheel is mounted on the hub. The hollow main body portion has internal threads with an open first end to thread on a hub bolt. A tool engaging portion shown as a multi-sided head portion at a second end of the shaft portion opposite the first end is engaged by a wrench for rotating the main body portion to thread and un-thread the main body portion on the hub bolt. In use, with the wheel on the hub, three centering pins are threaded on three bolts, preferably at 120 degree intervals. The wheel nuts are threaded on the remaining bolts and tightened. The centering pins are removed and replaced by wheel nuts that are also tightened.

Another centering device disclosed has a hollow body with a wheel centering sleeve portion that fits in a wheel aperture when the wheel is mounted on a hub with a bolt extending through each wheel aperture and three devices are used to center the wheel on the hub. A flange portion at one end of the sleeve portion limits the extent of insertion of the sleeve portion. Another centering device disclosed has a nut portion at one end of the sleeve portion that threads on the hub bolt. These devices are installed at the same three locations on the wheel above described and remain on the wheel during vehicle usage.

### DETAILED DESCRIPTION OF THE DRAWINGS

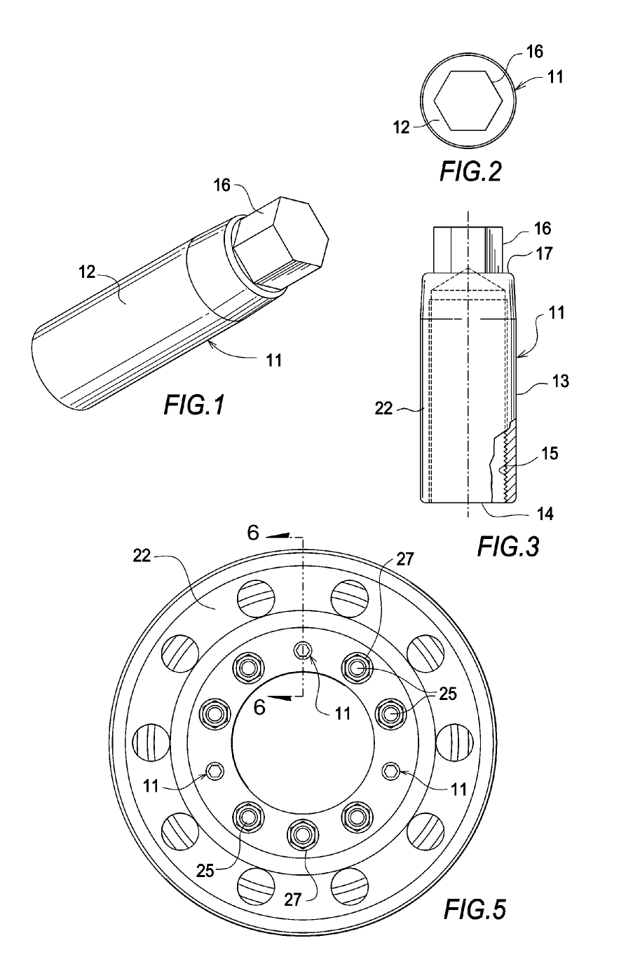

FIG. 1 is a perspective view of a wheel centering pin embodying features of the present invention.

FIG. 2 is a top view of FIG. 1.

FIG. 3 is a side elevation view of FIG. 1 partially broken away to show internal threads.

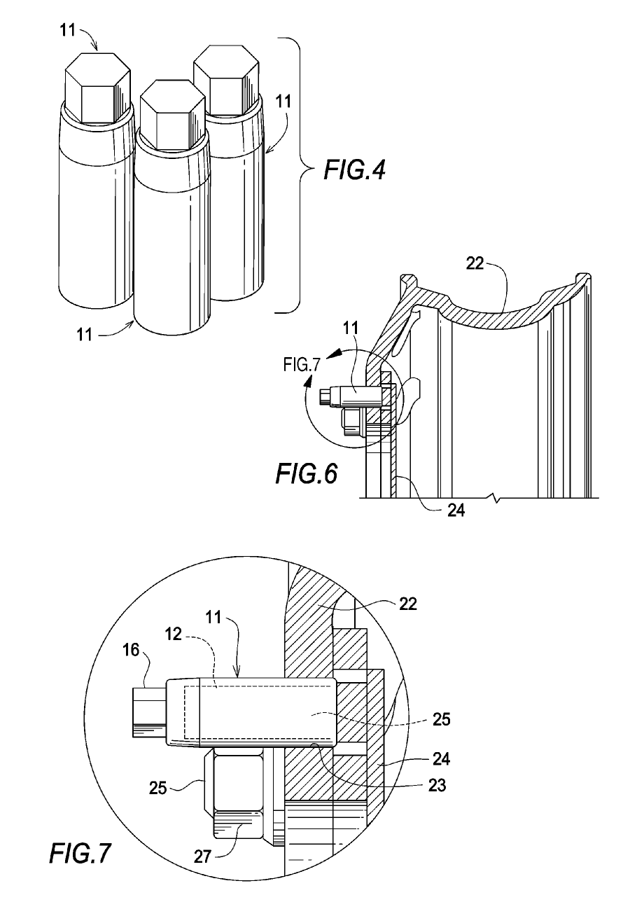

FIG. 4 is a perspective view showing a set of three of the centering pins shown in FIG. 1.

FIG. 5 is a front elevation view of a wheel mounted on a hub with three centering pins of FIG. 1, centering the wheel on the hub and wheel nuts on the remaining bolts.

FIG. 6 is a sectional view taken along line 6-6 of FIG. 5.

FIG. 7 is an enlarged view of a portion of FIG. 6.

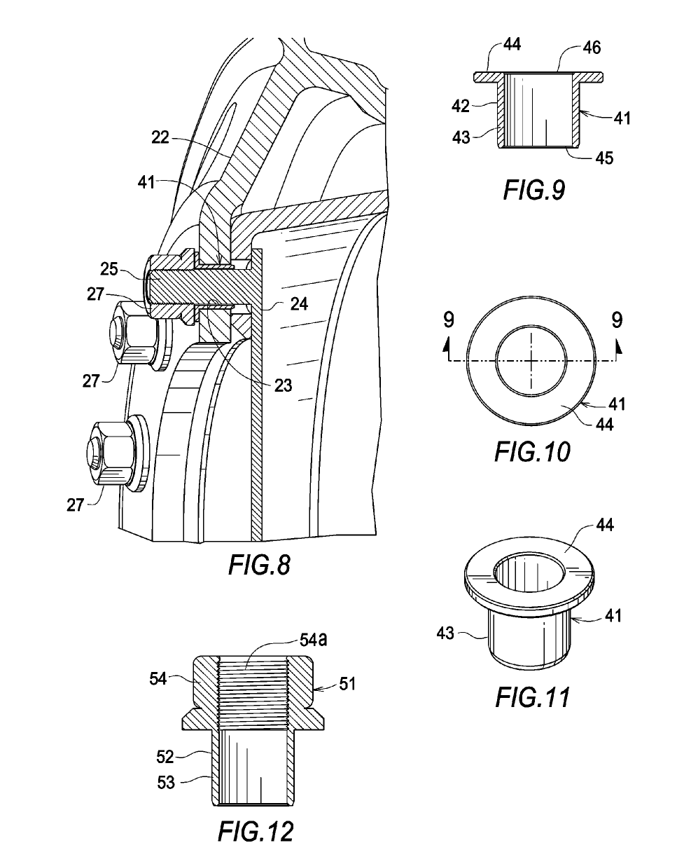

FIG. 8 is a fragmentary perspective view of another form of centering device shown mounted on a hub and wheel assembly.

FIG. 9 is a sectional view taken along line 9-9 of FIG. 10 of the device shown in FIG. 8.

FIG. 10 is a top plan view of the device shown in FIGS. 8 and 9.

FIG. 11 is a top perspective view of the device shown in FIGS. 8-10.

FIG. 12 is a sectional view of another form of centering device embodying features of the present invention.

Referring now to FIGS. 1-3, there is shown a wheel centering pin or device 111 embodying features of the present invention. Each wheel centering pin 11 has a hollow main body with a sleeve portion 12 of cylindrical shape, having a cylindrical, smooth exterior surface 13 of uniform diameter that is sized to slide into and substantially fill one of the wheel apertures described hereinafter. The main body portion 12 terminates in an open first end 14 and has internal threads 15. A tool engageable portion 16 at a closed second end 17 opposite the first end 14 is engaged by a tool or wrench for rotating the portion 16 and shaft portion 12 to thread and un-thread the shaft portion on a hub bolt described hereinafter. The tool engageable portion 16 shown is a multi-sided head portion of hexagonal shape to be engaged by a conventional wrench. Other tool engageable portions such as a screw driver slot could be used. The pin 11 preferably is made as a one piece construction with the main body portion 12 and tool engageable portion 16 formed together from metal such as mild steel that is heat treated for wear. The centering pins 11 are preferably provided as a set of three as shown in FIG. 4.

Referring now to FIGS. 4-7, there is shown a truck wheel 22 of the UNI-Mount type without the tire having ten circumferentially spaced apertures 23 at 36 degree intervals. The wheel 22 is shown mounted on a hub 24 having ten circumferentially spaced, studs or bolts 25 each of which extends through an associated wheel aperture 23 when the wheel 22 is mounted on the hub 24. Seven flanged wheel nuts 27 are shown threaded on seven of the bolts 25. Three identical wheel centering pins 11 are shown threaded on three bolts 25 at 120 degree intervals and specifically at twelve, four and eight o'clock positions.

In use, in carrying out the method of the present invention, the vehicle is elevated and the wheel nuts are removed from the hub 14. Three centering pins 11 are threaded on three hub bolts ant 120 degree intervals. Seven wheel nuts 27 are installed on the remaining hub bolts and tightened. The centering pins 11 are removed by un-threading. Three wheel nuts 27 are threaded on the three remaining bolts. Finally, all wheel nuts 27 are firmly tightened.

Referring now to FIGS. 8-11, there is shown another form of a centering device 41 having a hollow body 42 with a wheel centering sleeve portion 43 and a flange portion 44 at one end of portion 43. The sleeve portion 43 is sized to slide into the wheel aperture when the wheel is mounted on the hub with an associated hub bolt extending through the sleeve and substantially fill the wheel aperture. The body 42 has an open first end 45 and an open second end 46 opposite the first end. Flange portion 44 is at end 46 and limits the extend of insertion of the sleeve centering portion 43 into the wheel aperture. In use the device 41 is inserted in the wheel aperture 23 after the wheel 22 is placed in position on the hub 24 with the bolts 25 in the apertures 23 as shown. In use, six of the devices 41 are provided as a kit. Three of the devices are installed on each wheel but are used differently from that previously described as they remain on the wheel during vehicle usage.

Referring the FIG. 12, another form of centering device 51 has a hollow body 52 with a wheel centering sleeve portion 53 and a nut portion 54 at one end of portion 53 with the nut portion having internal threads 54a that allow the body 51 to be threaded on the hub bolt 25 to locate the sleeve portion in an associated wheel aperture to substantially fill the wheel aperture space between the bolt and the inside of the wheel aperture. In use, six of the devices 51 are furnished as a kit. Three of the devices 51 are installed on each wheel as above described with reference to device 41 and remain on the wheel during vehicle usage.

From the foregoing it is apparent the wheel centering pins are easily installed and removed. The device has been found effective in providing balanced wheels and thereby minimize wheel vibration and tire wear.

Although the present invention has been described with a certain degree of particularity, it is understood that the present disclosure has been made by way of example and that changes in details of structure may be made without departing from the spirit thereof.

What is claimed is:

1. A centering device comprising:
a hollow main body with a sleeve portion having an exterior surface of uniform diameter and sized to slide into one of a plurality of apertures on a wheel when the wheel is mounted on a hub having a plurality of bolts, said main body portion terminating in an open first end, said main body having internal threads to enable said main body to be threaded on one of said bolts and,
a tool engageable portion at a second end of said main body portion opposite said first end that is engaged by a tool for rotating said tool engageable portion to thread and un-thread said main body portion,
whereby upon the installation of a set of three devices on selected of three circumferentially spaced bolts said wheel is centered on said hub and a nut is tightened on each remaining of said bolts to fasten said wheel to said hub after which said devices are removed.

2. The device as set forth in claim 1 wherein said sleeve portion is of cylindrical shape.

3. The device as set forth in claim 1 wherein said tool engageable portion is a multi-sided head.

4. The device as set forth in claim 3 wherein said head is hexagonal in shape.

5. The device as set forth in claim 1 wherein said exterior surface of said sleeve portion is cylindrical and smooth.

6. The device as set forth in claim 1 wherein said sleeve portion substantially fills said wheel aperture and being slidable therein.

7. The device as set forth in claim 1 wherein said set of three centering devices are installed on bolts disposed at 120 degree intervals on said hub.

8. The device as set forth in claim 1 wherein said three devices are at twelve, four and eight o'clock positions.

9. The device as set forth in claim 1 wherein said sleeve portion and tool engageable portion are of a one piece metal construction.

10. A wheel centering device comprising:
a hollow main body with a sleeve portion having a smooth exterior surface of uniform diameter and sized to slide into one of a plurality of circumferentially spaced apertures on a wheel when the wheel is mounted on a hub having a plurality of circumferentially spaced bolts, said main body terminating in an open first end, said exterior surface of said sleeve portion is cylindrical and smooth, substantially fills said wheel aperture and is slidable therein, said main body having internal threads to enable said main body to be threaded on one of said bolts and,
a tool engageable portion at a second end of said main body opposite said first end that is engaged by a tool for rotating said sleeve portion to thread and un-thread said sleeve portion, the said tool engageable portion is a hexagonal head,
whereby upon the installation of a set of three centering devices on selected of three circumferentially spaced bolts said wheel is centered on said hub and a nut is tightened on each remaining of said bolts to fasten said wheel to said hub after which said centering devices are removed.

11. A wheel centering device for use as a set of three that are temporarily installed on selected circumferentially spaced bolts on a hub for a wheel having a plurality of circumferentially spaced apertures of uniform diameter, the device comprising:
a hollow cylindrical shaped main body with a sleeve portion having a smooth, exterior surface of uniform diameter and sized to slide into one of said wheel apertures and substantially fill said aperture to center said wheel on said hub, said sleeve portion having a socket terminating in an open first end having,
an internally threaded portion to enable said sleeve portion to be threaded on one of said threaded bolts and,
a wrench engaging head portion of hexagonal shape at a closed second end of said main body opposite said first end that is engaged by a wrench of a selected size to rotate said head portion to thread and un-thread said sleeve portion on said one threaded bolt,
whereby upon the installation of said set of three devices on selected of three circumferentially spaced bolts said wheel is centered on said hub and a nut may be tightened on each of remaining of said bolts to fasten said wheel to said hub after which said centering devices are removed from associated of said bolts.

12. A wheel centering kit comprising:
a set of three identical centering devices that are temporarily installed on selected of a plurality of circumferentially spaced threaded bolts on a hub for a wheel having a plurality of circumferentially spaced apertures of uniform diameter, each device having,
a hollow main body with a sleeve portion having a smooth, exterior surface of uniform diameter and sized to slide into one of said wheel apertures to center the wheel on said hub, said main body terminating in an open first end having,
an internally threaded portion to enable said sleeve portion to be threaded on one of said bolts and,
a tool engageable portion at a second end opposite said first end that is engaged by a tool to rotate said tool engageable portion to thread and un-thread said sleeve portion on said one bolt,
whereby upon the installation of said set of three devices on selected of three circumferentially spaced bolts said wheel is centered on said hub and a wheel nut is tightened on each remaining of said threaded bolts to fasten said wheel to said hub after which said set of three devices are removed from associated of sad threaded bolts.

13. A method of centering a wheel having circumferentially spaced apertures of uniform diameter on a hub having circumferentially spaced bolts comprising the steps of:
mounting the wheel on the hub with said bolts in said apertures,
threading three centering devices on three of said bolts,
threading nuts on the remaining of said bolts,
removing the centering devices, and
threading nuts on the remaining three of said bolts.

14. The method as set forth in claim 13 wherein said three centering devices are mounted at 120 degree intervals.

15. A centering device comprising:
a hollow body having a wheel centering sleeve portion sized to fit in a selected one of a plurality of circumferentially spaced wheel apertures when a wheel is mounted on a hub having a plurality of circumferentially spaced bolts in said wheel apertures,
whereby upon the installation of a set of three of said hollow bodies on a selected three of said circumferentially spaced bolts said wheel is centered on said hub.

16. The centering device as set forth in claim 15 wherein said body has a flange portion at one end that extends radially out from one end of said sleeve portion to limit the extent of insertion of said sleeve portion into an associated wheel aperture.

17. The centering device as set forth in claim 15 wherein said hollow body has a nut portion with internal threads at one end of said sleeve portion that extends radially out from said sleeve portion to enable said nut portion to be threaded on an associated bolt to locate said sleeve portion into said selected one of said wheel apertures.

18. The centering device as set forth in claim 15 wherein said sleeve portion substantially fills an associated of said wheel apertures and is slidable therein.

19. The centering device as set forth in claim 15 wherein said set of three centering devices are installed on bolts disposed at 120 degree intervals on said hub.

20. The centering device as set forth in claim 15 wherein said set of centering devices disposed at twelve, four and eight o'clock positions.

21. A centering device comprising:
a hollow body having a wheel centering sleeve portion sized to fit in a selected one of a plurality of circumferentially spaced wheel apertures when a wheel is mounted on a hub having a plurality of circumferentially spaced bolts in said wheel apertures,
said sleeve portion substantially filling said wheel aperture and being slidable therein,
whereby upon the installation of a set of three of said hollow bodies on a selected three of said circumferentially spaced bolts said wheel is centered on said hub,
said set of centering devices disposed at 120 degree intervals on said hub.

22. A wheel centering kit comprising:
a set of six identical centering devices that are installed on selected of a plurality of circumferentially spaced threaded bolts on a hub for a wheel having a plurality of circumferentially spaced apertures of uniform diameter, each device having,
a hollow main body with a sleeve portion and sized to fit into one of said wheel apertures to center the wheel on said hub,
whereby upon the installation of said set of three devices on selected of three circumferentially spaced bolts said wheel is centered on said hub and said centering devices remain on said wheel during vehicle usage.

23. A method of centering a wheel on a hub comprising the steps of:
mounting said wheel having circumferentially spaced wheel apertures on said hub having a plurality of circumferentially spaced bolts extending through associated of said wheel apertures,
installing a centering device having a hollow body with a wheel centering sleeve portion extending in each of three selected associated wheel apertures to center said wheel on said hub.

24. The method as set forth in claim 23 wherein said centering devices remain on said wheel during vehicle usage.
